(19) United States
(12) Patent Application Publication
(10) Pub. No.: US 2009/0259398 A1
(43) Pub. Date: Oct. 15, 2009

(54) NAVIGATIONAL DIRECTION INDICATING DEVICE

(75) Inventor: Peng-Hui Wang, Taoyuan (TW)

Correspondence Address: LAW OFFICES OF MIKIO ISHIMARU, 333 W. EL CAMINO REAL, SUITE 330, SUNNYVALE, CA, 94087, US

(73) Assignee: MITAC INTERNATIONAL CORPORATION, Taoyuan (TW)

(21) Appl. No.: 12/422,961

(22) Filed: Apr. 13, 2009

(30) Foreign Application Priority Data
Apr. 14, 2008 (TW) 097113451

(51) Int. Cl. G01C 21/00

(52) U.S. Cl. 701/213

(57) ABSTRACT

A navigational direction-indicating device includes a Global Positioning System (GPS), a display unit, an activation control unit, a navigation software for generating a direction guidance instruction according to positioning signals received by the GPS, and a plurality of light emitting elements arranged proximate to the display unit. After the navigation software generates the direction guidance instruction, the activation control unit generates activation signals according to the direction guidance instruction and corresponding to the light emitting elements, respectively, so as for a corresponding one of the light emitting elements to emit light, thereby allowing a user to receive the guidance instruction efficiently.

### BACKGROUND OF THE INVENTION

1. Field of the Invention

The present invention relates to navigation technologies, and more particularly, to a navigational direction-indicating device applied to a navigation device with a display unit.

2. Description of Related Art

Compared with conventional maps on paper, vehicle navigation devices with Global Positioning System (GPS) functionality provide map and route instruction more quickly and conveniently and are being increasingly utilized by drivers.

Generally, a vehicle navigation device at least comprises a navigation display screen, which displays the location of the vehicle on an electronic map, speed of the vehicle, direction, and distance to a destination or a turning point. FIG. 1 shows an example of the appearance of a conventional navigation display screen 1. As shown in FIG. 1, the navigation display screen 1 comprises a first display block 10 with a large area and a second display block 12 with a relatively small area. The first display block 10 displays an electronic map of the area where the vehicle is located, wherein instructions such as road types, road names, road junctions, attributes, two-dimensional coordinates and other related traffic instructions can be displayed. Further, the first display block 10 displays instruction about the current road and the next junction or road. The second display block 12 displays the next turn direction (indicated as an arrow) and the distance to the turn according to a guidance route determined by a navigation system or driver so that the driver can be ready for making a turn in advance, such as slowing down or signaling.

However, the size of the navigation display screen must be kept small to ensure portability if the device is removable. In particular, for a vehicle navigation device, the size of the navigation display screen needs to be kept small since the size of the navigation display screen is further limited by the amount of available vehicle space, yet it still needs to facilitate easy viewing for the driver. The navigation display screen 1 having an already small size is further divided into the first display block 10 and the second display block 12, and the electronic map displayed in the first display block 10 is often quite small. However, the small map size may cause the driver to look at the display screen for a long period of time, compromising safe vehicle operation.

Currently, most of the navigation devices provide voice guidance to prompt a driver to turn left/right or go straight during the navigation process. However, the voice prompts may be overwhelmed by environmental noise such as traffic sounds, speech or music. Thus, a driver may miss such prompts or need to focus on listening so intently that attention is distracted from traffic situations, thereby increasing the risk of accidents.

In order to overcome the above-described drawbacks wherein a driver focuses on the small screen of the navigation device to such an extent or listens for voice prompts so intently that distraction occurs, another kind of navigation device has been developed, wherein light emitting elements are arranged proximate to the navigation display screen so as to notify the driver of a change in travel direction through illumination of the light emitting elements. Such illuminated guidance often enables easier comprehension in comparison to display screen guidance and voice guidance. However, such a navigation device only communicates that a change of travel direction is to be made, and the driver still needs to look at the navigation display screen to obtain more detailed instruction of such as the approximate time until the turn or whether the turn has been missed, and so on. Therefore, the above-described drawback wherein a driver's attention is liable to be distracted while concentrating on the navigation display screen is not overcome.

Therefore, there is a need to provide a navigational direction-indicating device so as to overcome the above-described drawbacks.

### SUMMARY OF THE INVENTION

In order to overcome the above drawbacks, the present invention provides a navigational direction-indicating device for giving a driver timely an instruction about a change of travel direction.

The present invention further provides a navigational direction-indicating device whereby a driver conveniently obtains an instruction about a change of travel direction without having to focus attention on the display screen of a navigation device, thereby improving driving safety.

The present invention further provides a navigational direction-indicating device that can enhance utilization of a display unit of a navigation device.

In accordance with the present invention, a navigational direction-indicating device that is applied to a navigation device comprises a display unit, a Global Positioning System (GPS), and a navigation software, wherein the navigation software performs route guidance and generates a direction guidance instruction according to positioning signals received by the GPS. The navigational direction-indicating device comprises a plurality of light emitting elements and an activation control unit, wherein the direction guidance instruction comprises instructions indicating preparing for a left turn, making a left turn, having missed a left turn, preparing for a right turn, making a right turn, and having missed a right turn, and wherein the light emitting elements are arranged proximate to the display unit so as to correspond to the different direction guidance instruction scenarios. Hence, after the navigation software has generated a direction guidance instruction, the activation control unit generates activation signals according to the direction guidance instruction and corresponding to the light emitting elements, respectively, so as for a corresponding one of the light emitting elements to emit light.

According to the present invention, the navigational direction-indicating device comprises a plurality of light emitting elements disposed at different positions and arranged proximate to a display unit corresponding to the different direction guidance instruction scenarios such that, when it is determined that a change of travel direction is to be made at a next junction according to the route guidance, the light emitting element corresponding to the upcoming change of direction is activated to emit light, thereby timely prompting a driver to change direction so as to enhance utilization of the display unit and increase driving safety.

### BRIEF DESCRIPTION OF DRAWINGS

FIG. 1 shows an example of the appearance of a display screen of a conventional navigational direction-indicating device;

FIG. 2 is a block diagram of a navigational direction-indicating device according to the present invention; and

FIG. 3 shows an example of the appearance of a display unit applied to a navigational direction-indicating device according to the present invention.

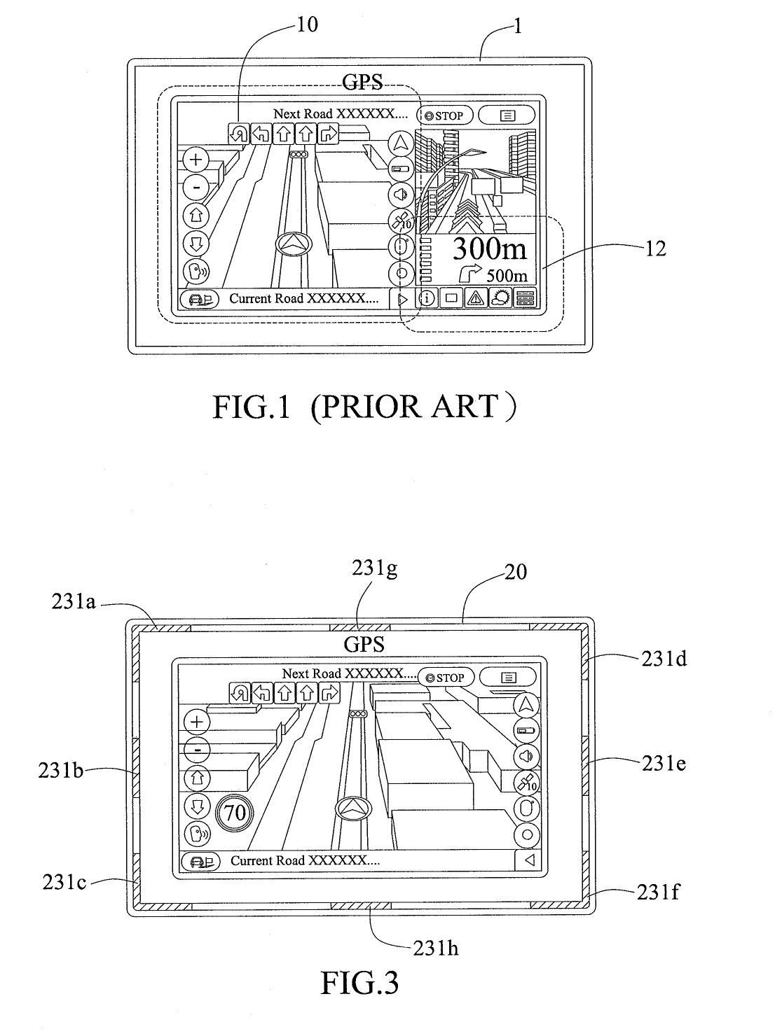

### DETAILED DESCRIPTION OF PREFERRED EMBODIMENTS

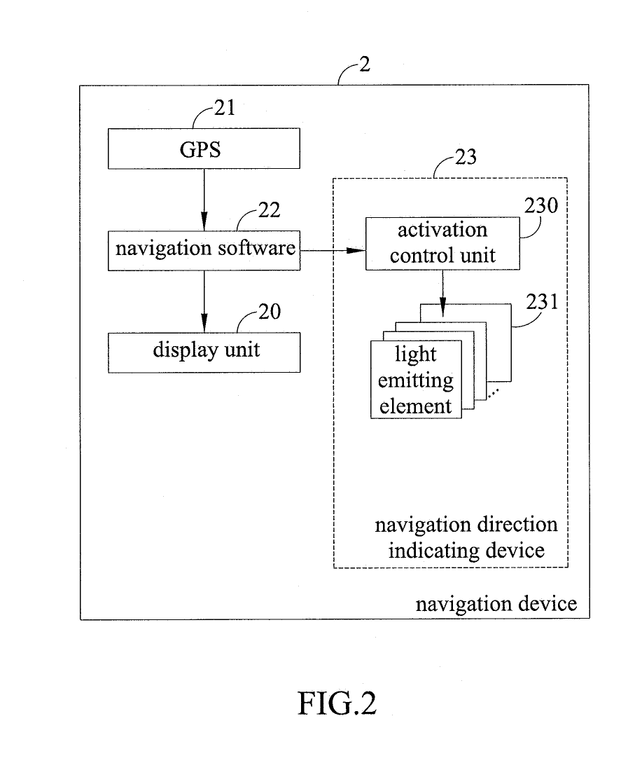

The following illustrative embodiments are provided to illustrate the disclosure of the present invention. These and other advantages and effects will be apparent to those skilled in the art after reading the disclosure of this specification. FIG. 2 is a block diagram of a navigational direction-indicating device according to the present invention. As shown in the drawing, the navigational direction-indicating device 23 is applied to a navigation device 2 for indicating navigational instruction, wherein the navigation device 2 comprises a display unit 20, a Global Positioning System (GPS) 21, and a navigation software 22 executable by an electronic apparatus electrically connected to the navigational direction-indicating device to generate a direction guidance instruction according to positioning signals received by the GPS 21. In the present embodiment, the navigation device is installed in or utilized in, but not limited to, a vehicle such as a car. The navigational direction-indicating device 23 can also be applied to portable electronic devices having a navigation function such as personal digital assistants (PDAs), mobile phones or notebook computers. As shown in the drawing, the navigational direction-indicating device 23 comprises an activation control unit 230 and a plurality of light emitting elements 231. The navigational direction-indicating device 23 is helpful to enhance the turn indication effect of direction guidance. The navigational direction-indicating device 23 is operated in combination with the navigation software 22 of the navigation device 2. The navigation software 22 determines the current geographical coordinates of a vehicle (or any other object equipped with the navigation device 2) through the GPS 21, determines an optimal guidance route for a system or user selected destination and displays it via an electronic map, and provides direction guidance instruction to the display unit 20 for display. GPS positioning technology and the functions provided by the navigation software are both well known in the art, and thus detailed descriptions thereof are omitted herein.

The light emitting elements 231 of the navigational direction-indicating device 23 are arranged proximate to the display unit 20, wherein the light emitting elements 231 are, for example, light emitting diodes. The light emitting elements 231a to 231h each have a strip structure and are arranged proximate to the display unit 20. In the present embodiment, the light emitting elements 231a to 231h are disposed at the corners and sides of the display unit 20. The light emitting elements are disposed at different positions for providing different direction guidance instruction scenarios, such as continuing straight, making a U-turn, preparing for a left turn, preparing for a right turn, making a left turn, making a right turn, having missed a right turn, and having missed a left turn. As shown in FIG. 3, the light emitting element 231a disposed at the upper left corner of the display unit 20 corresponds to the direction guidance instruction indicating preparing for a left turn; the light emitting element 231b disposed at the left side of the display unit 20 corresponds to the direction guidance instruction indicating making a left turn; the light emitting element 231c disposed at the lower left corner of the display unit 20 corresponds to the direction guidance instruction indicating having missed a left turn; the light emitting element 231d disposed at the upper right corner of the display unit 20 corresponds to the direction guidance instruction indicating preparing for a right turn; the light emitting element 231e disposed at the right side of the display unit 20 corresponds to the direction guidance instruction indicating making a right turn; the light emitting element 231f disposed at the lower right corner of the display unit 20 corresponds to the direction guidance instruction indicating having missed a right turn; the light emitting element 231g disposed at the upper side of the display unit 20 corresponds to the direction guidance instruction indicating continuing straight; and the light emitting element 231h disposed at the lower side of the display unit 20 corresponds to the direction guidance instruction indicating making a U-turn.

Illumination of the light emitting elements 231a to 231h is controlled by the activation control unit 230, wherein the operation of the activation control unit 230 is controlled by the navigation software 22. After the navigation software 22 performs route guidance and generates a direction guidance instruction according to positioning signals received by the GPS 21, the activation control unit 230 generates activation signals according to the direction guidance instruction. For example, on the way to a destination, if a left turn is to be made at the next junction, the activation control unit 230 sends an activation signal indicating preparing for a left turn such that the activation control unit 230 causes a corresponding one of the light emitting elements 231 to emit light according to the activation signal.

The light emitting elements 231 disposed at different positions and arranged proximate to the display unit 20 emit light according to an activation signal generated by the activation control unit 230 such that a driver can conveniently know the travel direction at the next junction according to the illumination of the light emitting elements 231.

In the present embodiment, the light emitting elements 231 emit a steady light or a flashing light to clearly indicate the travel direction at the next junction so as to enable a driver to get prepared in advance.

In conclusion, the navigational direction-indicating device of the present invention has a plurality of light emitting elements disposed at different positions and arranged proximate to a display unit in a way corresponding to different direction guidance instruction scenarios, such that when it is determined that a change of travel direction is to be made at the next junction according to the route guidance functionality, the light emitting element corresponding to the change of direction is activated to emit light so as to timely prompt a driver to get prepared in advance. In addition, compared with the prior art that uses a part of the display area of a display unit for displaying the navigational direction instruction and therefore decreases the display area available for an electronic map, the present invention has the light emitting elements arranged proximate to the display unit, thereby enhancing the utilization of the display area of the display unit while allowing the driver to more readily obtain instruction about a change of travel direction so as to assure driving safety.

The above-described descriptions of the detailed embodiments are provided to illustrate the preferred implementation according to the present invention, and they are not intended to limit the scope of the present invention. Accordingly, various modifications and variations that may be completed by those with ordinary skill in the art should be considered to fall within the scope of present invention as defined by the appended claims.

What is claimed is:

1. A navigational direction-indicating device, comprising:
a Global Positioning System (GPS);
a display unit;
a plurality of light emitting elements arranged proximate to the display unit; and
a navigation software executable by an electronic apparatus electrically connected to the navigational direction-indicating device to generate a direction guidance instruction according to positioning signals received by the GPS;
wherein the direction guidance instruction comprises instructions indicating preparing for a left turn, making a left turn, having missed a left turn, preparing for a right turn, making a right turn, and having missed a right turn, and
wherein the light emitting elements are positioned proximate to the display unit so as for the light emitting elements to emit light respectively corresponding to the instructions.

2. The device of claim 1, further comprising an activation control unit electrically connected to each of the light emitting elements and configured to generate activation signals according to the instructions, respectively, so as for a corresponding one of the light emitting elements to emit light.

3. The device of claim 1, wherein the light emitting element corresponding to the instruction indicating preparing for a left turn is disposed at an upper left corner of the display unit, the light emitting element corresponding to the instruction indicating making a left turn is disposed at a left side of the display unit, the light emitting element corresponding to the instruction indicating having missed a left turn is disposed at a lower left corner of the display unit, the light emitting element corresponding to the instruction indicating preparing for a right turn is disposed at an upper right corner of the display unit, the light emitting element corresponding to the instruction indicating making a right turn is disposed at a right side of the display unit, and the light emitting element corresponding to the instruction indicating having missed a right turn is disposed at a lower right corner of the display unit.

4. The device of claim 1, wherein the direction guidance instruction further comprises instructions indicating continuing straight and making a U-turn, and the light emitting elements corresponding to the instructions indicating continuing straight and making a U-turn are disposed at the upper and lower sides of the display unit, respectively.

5. The device of claim 1, wherein the light emitting elements respectively have a strip structure.

6. The device of claim 1, wherein the light emitting elements are light emitting diodes.

7. The device of claim 1, wherein the light emitting elements emit steady or flashing light.

8. The device of claim 4, wherein the light emitting elements respectively have a strip structure.

9. The device of claim 4, wherein the light emitting elements are light emitting diodes.

10. The device of claim 4, wherein the light emitting elements emit steady or flashing light.
